(19) United States
(12) Patent Application Publication
(10) Pub. No.: US 2017/0064598 A1
(43) Pub. Date: Mar. 2, 2017

(54) Managing Cell Selection In A Dual-Receive Multi-Subscription Multi-Standby Communication Device

(71) Applicant: QUALCOMM Incorporated, San Diego, CA (US)

(72) Inventors: Sachin Jain, Santa Clara, CA (US); Dushyant Rana, Sunnyvale, CA (US); Jin-Sheng Su, San Diego, CA (US); Tom Chin, San Diego, CA (US)

(21) Appl. No.: 14/836,403

(22) Filed: Aug. 26, 2015

(51) Int. Cl. H04W 36/14; H04W 48/18

(52) U.S. Cl. CPC H04W 36/14; H04W 48/18

(57) ABSTRACT

Embodiments include systems and methods for managing cell selection performed in a multi-subscription multi-standby communication device. A device processor may operate the multi-subscription multi-standby communication device in a full concurrency mode in communication with a first cell and a second cell. The device processor may determine whether a detected third cell supports operation of the multi-subscription multi-standby communication device in the full concurrency mode. The device processor may perform cell reselection to the detected third cell in response to determining that the detected third cell supports operation of the multi-subscription multi-standby communication device in the full concurrency mode.

### BACKGROUND

A multi-subscription multi-standby (MSMS) communication device may include two or more subscriber identity module (SIM) cards, each associated with a different service provider subscription. Multi-subscription multi-standby communication devices may be provided in a range of configurations, including a dual-subscription dual-standby (DSDS) configuration, in which two SIMs share a set of receive (Rx) circuitry (referred to as an “Rx chain”). Multi-subscription multi-standby communication devices may also be configured to utilize a variety of radio access technology (RAT) protocols (e.g., 3GPP Long Term Evolution (LTE), Global System for Mobility (GSM), and Wideband Code Division Multiple Access (WCDMA).

A multi-subscription multi-standby communication device may be configured as a dual receive (DR) device (DR-MSMS), in which the multi-subscription multi-standby communication device has a radio frequency (RF) resource (e.g., a transceiver) that includes one set of transmit (Tx) circuitry (referred to as a “Tx chain”) and two (or more) RF chains. While a DR-MSMS device may typically only transmitting using a single RAT at a time because the DR-MSMS communication device includes one Tx chain, the DR-MSMS communication device may simultaneously receive signals using two (or more) different RATs.

A DR-MSMS communication device may also employ a “tune-away” procedure by tuning one Rx chain away to a second network in a second cell for a short time, and then tuning the Rx chain back to the first network. This tune-away procedure may allow the multi-subscription multi-standby communication device to monitor for pages or other indications of incoming messages or data received on the second network. However, tuning away to another network may decrease the throughput of communications between the multi-subscription multi-standby communication device and the first network, and may degrade the quality of an active communication session over the first network.

### SUMMARY

Various embodiments include methods and multi-subscription multi-standby communication devices implementing the methods for managing cell selection to prefer selection of cells that enable the multi-subscription multi-standby communication devices to operate in a full concurrency mode. Various embodiments include preferentially selecting cells for reselection that will enable full concurrency mode operation by the multi-subscription multi-standby communication device.

In some embodiments, preferentially selecting cells for reselection that will enable full concurrency mode operation by the multi-subscription multi-standby communication device while operating in full concurrency mode may include determining whether a first detected cell having a signal level superior to a signal level of a current cell will enable full concurrency mode operation by the multi-subscription multi-standby communication device, performing cell reselection to the first detected cell in response to determining that the first detected cell will enable full concurrency mode operation by the multi-subscription multi-standby communication device, determining whether the current cell can receive paging messages in response to determining that the first detected cell will not enable full concurrency mode operation by the multi-subscription multi-standby communication device, not performing cell reselection to the first detected cell in response to determining that the current cell can receive paging messages, and performing cell reselection to the first detected cell and begin operating in a non-full concurrency mode in response to determining that the current cell cannot receive paging messages. In some embodiments, preferentially selecting cells for reselection that will enable full concurrency mode operation by the multi-subscription multi-standby communication device while operating in the non-full concurrency mode may include determining whether a second detected cell having a signal level superior to a signal level of a current cell will enable full concurrency mode operation by the multi-subscription multi-standby communication device, determining whether the second detected cell will enable receiving paging messages in response to determining that the second detected cell will enable full concurrency mode operation by the multi-subscription multi-standby communication device, not performing cell reselection to the second detected cell in response to determining that the second detected cell will not enable receiving paging messages, and performing cell reselection to the second detected cell and begin operating in a full concurrency mode in response to determining that the second detected cell will enable receiving paging messages.

In some embodiments preferentially selecting cells for reselection that will enable full concurrency mode operation by the multi-subscription multi-standby communication device while operating in full concurrency mode may include adjusting a first signal strength threshold for initiating cell reselection to decrease a probability of performing cell reselection, determining whether a first detected cell having a signal level superior to a signal level of a current cell exhibits a signal strength that exceeds the adjusted first signal strength threshold, determining whether the first detected cell will enable full concurrency mode operation by the multi-subscription multi-standby communication device in response to determining that the first detected cell exhibits a signal strength that exceeds the adjusted first signal strength threshold, performing cell reselection to the first detected cell in response to determining that the first detected cell will enable full concurrency mode operation by the multi-subscription multi-standby communication device, determining whether the current cell can receive paging messages in response to determining that the first detected cell will not enable full concurrency mode operation by the multi-subscription multi-standby communication device, not performing cell reselection to the first detected cell in response to determining that the current cell can receive paging messages, and performing cell reselection to the first detected cell and begin operating in a non-full concurrency mode in response to determining that the current cell cannot receive paging messages. In some embodiments, preferentially selecting cells for reselection that will enable full concurrency mode operation by the multi-subscription multi-standby communication device while operating in the non-full concurrency mode may include adjusting a second signal strength threshold for initiating cell reselection to increase a probability of performing cell reselection, determining whether a second detected cell exhibits a signal strength that exceeds the adjusted second signal strength threshold, determining whether the second detected cell will enable receiving paging messages in response to determining that the second detected cell will enable full concurrency mode operation by the multi-subscription multi-standby communication device, not performing cell reselection to the second detected cell in response to determining that the second detected cell will not enable receiving paging messages, and performing cell reselection to the second detected cell and begin operating in a full concurrency mode in response to determining that the second detected cell will enable receiving paging messages. In some embodiments, adjusting the first signal strength threshold for initiating cell reselection to decrease a probability of performing cell reselection may include increasing the first signal strength threshold, and adjusting the second signal strength threshold for initiating cell reselection to increase a probability of performing cell reselection may include decreasing the second signal strength threshold.

Further embodiments include a multi-subscription multi-standby communication device including a processor configured with processor-executable instructions for performing operations of the methods described above. Further embodiments include a multi-subscription multi-standby communication device having means for performing functions of the methods described above. Further embodiments include a non-transitory processor-readable medium on which is stored processor-executable instructions configured to cause a processor of a multi-subscription multi-standby communication device to perform operations of the methods described above.

### BRIEF DESCRIPTION OF THE DRAWINGS

The accompanying drawings, which are incorporated herein and constitute part of this specification, illustrate exemplary embodiments. Together with the general description given above and the detailed description given below, the drawings serve to explain features of the various embodiments, and not to limit the various embodiments.

FIG. 1 is a component block diagram of a communication system suitable for use with various embodiments.

FIG. 2 is a component block diagram of a multi-subscription multi-standby communication device according to various embodiments.

FIG. 3 is a process flow diagram illustrating a method for managing cell selection in a multi-subscription multi-standby communication device according to various embodiments.

FIG. 4 is a process flow diagram illustrating another method for managing cell selection in a multi-subscription multi-standby communication device according to various embodiments.

FIG. 5 is a component block diagram of a multi-subscription multi-standby communication device suitable for use with various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods implemented multi-subscription multi-standby communication devices that enable reception of cell broadcasts on a first network while reducing degradation of throughput of data of an active communication session on a second network by appropriately scheduling tune-aways to the first network.

The terms “multi-subscription multi-standby communication device” and “MSMS communication device” refer to any one or all of cellular telephones, smartphones, personal or mobile multi-media players, personal data assistants, laptop computers, tablet computers, smartbooks, palmtop computers, wireless electronic mail receivers, multimedia Internet enabled cellular telephones, wireless gaming controllers, and similar electronic devices and portable computing platforms which include a programmable processor, a memory, and one or more shared RF resources, and which are configured to support communications over two or more subscriptions. Various embodiments may be particularly useful in any communication devices that can support multiple wireless wide area network subscriptions and communication sessions with two or more communication networks. The terms “dual receive multi-subscription multi-standby communication device” and “DR-MSMS communication device” refers to a configuration of an MSMS communication device that includes two or more Rx chains, which enables the MSMS communication device to simultaneously receive signals using two or more different RATs.

The terms “component,” “module,” “system,” and the like as used herein are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

References to “first network,” “first subscription,” “second network” and “second subscription” are arbitrary and are used to refer to two or more subscriptions/networks generally because at any given time either subscription/network may be in an active mode (on an active voice or data call) or a standby mode. For example, at a first time, a first subscription with a first network may be on an active data call (and thus a “first subscription) while a second subscription with a second network is in the standby mode (and thus a “second” subscription), and at a second time, the second subscription may enter an active data call (becoming the “first” subscription) and the first subscription may enter the standby mode (becoming the “second” subscription). Also, references to “first” and “second” subscriptions and networks is not intended to imply that the embodiments are limited to two subscriptions sharing one radio frequency (RF) resource, because three or more subscriptions may share one RF resource provided that only one subscription can use the RF resource at a time. Third and fourth subscriptions would behave similar to a second subscription. Therefore, in the interest of brevity, operations of subscriptions in the standby mode that share the RF resource during tune-away periods are described generally with reference to the “second” subscription.

A DR-MSMS communication device may operate in various receive modes. In full concurrency (FC) mode, the DR-MSMS communication device may receive signals using two or more RATs using separate Rx chains simultaneously, eliminating the need to perform a tune-away procedure to the second RAT and any related impact on throughput to either RAT that may be caused by the tune-away procedure. In a diversity sharing mode (DTA), the first RAT may use a first Rx chain and a second Rx chain while a second RAT is not in use to achieve receive diversity, and the first RAT may lose access to the second Rx chain when the second RAT performs idle network monitoring operations (i.e., page monitoring, neighboring cell measurements, etc.). In a full tune-away mode, the first RAT may lose access to one or both Rx chains and the Tx chain during a tune away to the second RAT.

Since operation in the FC mode provides the least reduction in throughput for both (or all) RATs, it is preferable for the MSMS communication device to operate in the FC mode as much as possible. However, the MSMS communication device may not always be able to operation in the FC mode. For example, signal from two or more RATs may use signals with frequencies that overlap or are close together, leading to interference between the signals. This interference may prevent two RATs from receiving their respective signals simultaneously. In such a situation, the DR-MSMS communication device must select a different mode of receive operation. For example, the MSMS communication device may “fall back” to a full tune-away mode.

The various embodiments enable a processor of a multi-subscription multi-standby communication device to manage cell selection (or cell reselection) operations of the MSMS communication device to preferentially select cells that provide signals that allow the multi-subscription multi-standby communication device to operate in full concurrency (FC) mode. In various embodiments, when the multi-subscription multi-standby communication device is operating in the FC mode, the multi-subscription multi-standby communication device is communicating with two cells, each using a different RAT (e.g., LTE and GSM). While operating in the FC mode, the MSMS communication device may perform cell monitoring activities and may detect a third cell with a higher signal level than one of the two current cells. The signal level may include a signal strength (e.g., a Receive Signal Strength Indicator (RSSI), a Reference Signal Received Power (RSRP), or another indication of signal strength), a signal quality (e.g., a Channel Quality Indicator (CQI), a Reference Signal Received Quality (RSRQ), or another indication of signal quality), or another indication of signal level.

The MSMS communication device may determine whether the third cell supports FC operation by the MSMS communication device. For example, the MSMS communication device may determine that the signal of the third cell will not interfere with signal reception of the other RAT (e.g., the frequency band of the third cell will not interfere with the frequency band of the other RAT). In response to determining that the third cell supports FC operation by the MSMS communication device, the MSMS communication device may perform cell reselection to the third cell. However, in response to determining that the third cell does not support FC operation by the MSMS communication device, the MSMS communication device may not perform cell reselection to the third cell, even if the signal level of the third cell would ordinarily prompt the MSMS communication device to perform cell reselection. In various embodiments, the MSMS communication device may determine that the third cell's frequency band would interfere with the signal reception of the other RAT, and thus may determine that the third cell does not support FC operation by the MSMS communication device. Thus, the MSMS communication device may preferentially select cells for cell reselection including a signal that allows the MSMS device to operate in the FC mode.

In some embodiments, when the MSMS communication device is operating in the FC mode, the MSMS communication device may increase a signal level threshold required to select the third cell (i.e., to perform cell reselection to the third cell), so that the MSMS communication device is biased to remain camped on cells that permit operation in the FC mode.

However, due to changing conditions, such as the result of mobility of the MSMS communication device and/or changes in the RF environment causing a decreased signal level of one or more communication links and degraded signal quality of one or more communication links, one of the two current cells may be unable to support operation in the FC mode by the MSMS communication device. For example, the MSMS communication device may determine that the MSMS communication device can no longer receive paging message from one of the current cells. If one of the current cells becomes unable to support operation in the FC mode by the MSMS communication device, the MSMS communication device may perform cell reselection to a third cell that also does not support operation in the FC mode, and thus the MSMS communication device may operate in a non-FC mode (e.g., DTA mode, or full tune-away mode).

While operating in the non-FC mode, the MSMS communication device may monitor for another cell that supports operation in the FC mode. The MSMS communication device may perform cell reselection to another cell that supports operation in the FC mode when one is detected by the MSMS communication device (e.g., the MSMS communication device detects a third cell with a signal level above the threshold, or the MSMS communication device initiates cell reselection because the signal level of one of the current cells drops below a threshold). In some embodiments, if the signals of the current cells preclude FC mode operation by the MSMS device, the MSMS device may decrease a signal level threshold required to select another cell for cell reselection.

Thus, various embodiments enable the MSMS communication device to decrease a probability of performing cell reselection to a cell that will prevent the MSMS device from operating in the FC mode, and to increase a probability of performing cell reselection to a cell that will enable FC mode operation particularly when the device is not in the FC mode. In some embodiments, the MSMS communication device may adjust one or more signal level thresholds required for cell reselection of a new cell to increase a probability of performing cell selection to cells that support operation in the FC mode and/or to decrease a probability of performing reselection to cells that do not support operation of the MSMS communication device in the FC mode. In some embodiments, the MSMS communication device may ignore candidate third cells (e.g., by removing third cells from a candidate list) if a candidate third cell does not support FC operation by the MSMS communication device.

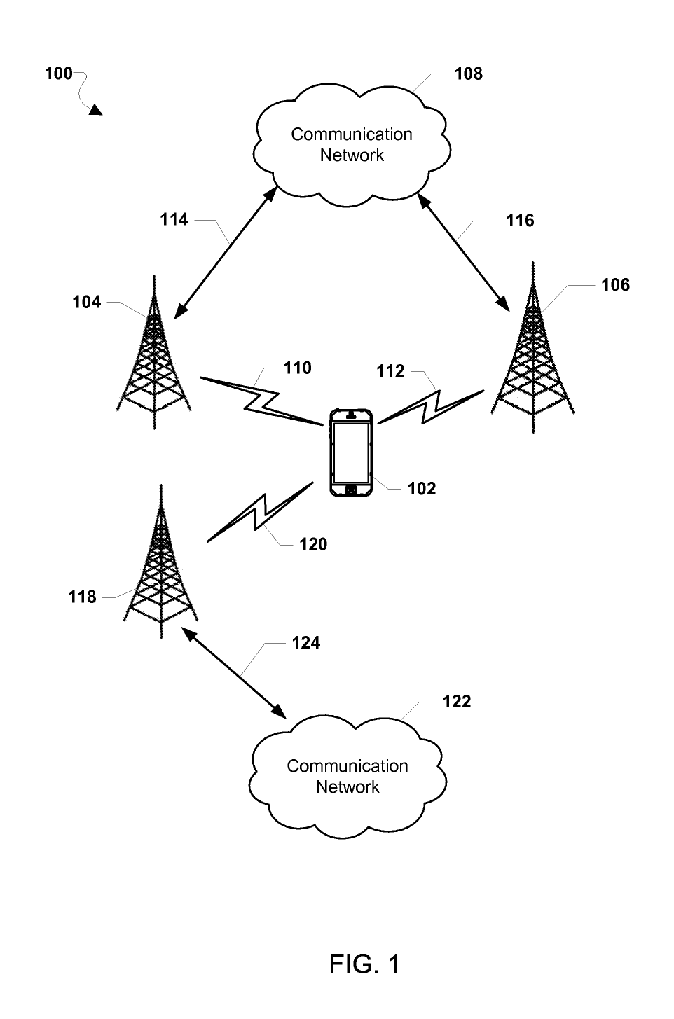

Various embodiments may be implemented in multi-subscription multi-standby communication devices that may operate within a variety of communication systems particularly systems that include two or more communication networks. FIG. 1 illustrates a communication system 100 suitable for use with various embodiments.

An MSMS communication device 102 may communicate with a communication network 108, which may include a plurality of base stations, such as base stations 104, 106. The MSMS communication device 102 may also communicate with a communication network 122, which may include a base station 118. The base station 104 may communicate with the communication network 108 over a wired or wireless communication link 114, which may include fiber optic backhaul links, microwave backhaul links and other similar communication links. The base station 106 may communicate with the communication network 108 over a wired or wireless communication link 116 similar to the communication link 114. The base station 118 may communicate with the communication network 122 over a wired or wireless communication link 124 similar to the communication link 114. In some embodiments, each communication network 108, 122 may include a mobile telephony communication network. The MSMS communication device 102 may communicate with the base station 104 over a wireless communication link 110, with the base station 106 over a wireless communication link 112, and with the base station 118 over a wireless communication link 120.

Each of the communication networks 108, 122 may support communications using one or more RATs, and each of the wireless communication links 110, 112, and 120 may include cellular connections that may be made through two-way wireless communication links using one or more RATs. Examples of RATs may include LTE, GSM, Worldwide Interoperability for Microwave Access (WiMAX), Code Division Multiple Access (CDMA), WCDMA, Time Division Multiple Access (TDMA), Single-Carrier Radio Transmission Technology (1×RTT), Evolution-Data Optimized (EV-DO), and other RATs. While the communication links 110, 112, and 120 are illustrated as single links, each of the communication links may include a plurality of frequencies or frequency bands, each of which may include a plurality of logical channels. Additionally, each of the communication links 110, 112, and 120 may utilize more than one RAT.

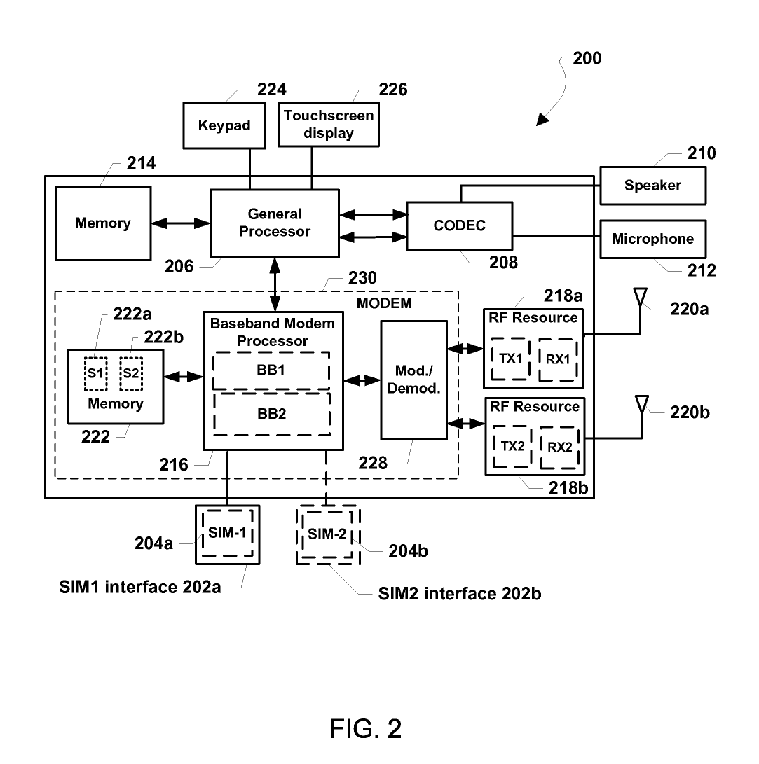

FIG. 2 is a component block diagram of an MSMS communication device 200 suitable for implementing various embodiments. With reference to FIGS. 1 and 2, in various embodiments, the MSMS communication device 200 may be similar to MSMS communication device 102. The MSMS communication device 200 may include a first SIM interface 202a, which may receive a first identity module SIM-1 204a that is associated with a first subscription. The MSMS communication device 200 may optionally also include a second SIM interface 202b, which may receive a second identity module SIM-2 204b that is associated with a second subscription.

A SIM in various embodiments may be a Universal Integrated Circuit Card (UICC) that is configured with SIM and/or USIM (Universal Subscriber Identity Module) applications, enabling access to, for example, GSM and/or Universal Mobile Telecommunications System (UMTS) networks. The UICC may also provide storage for a phone book and other applications. Alternatively, in a CDMA network, a SIM may be a UICC removable user identity module (R-UIM) or a CDMA subscriber identity module (CSIM) on a card. Each SIM card may have a CPU, ROM, RAM, EEPROM and I/O circuits. A SIM used in various embodiments may contain user account information, an international mobile subscriber identity (IMSI), a set of SIM application toolkit (SAT) commands and storage space for phone book contacts. A SIM card may further store a Home-Public-Land-Mobile-Network (HPLMN) code to indicate the SIM card network operator provider. An Integrated Circuit Card Identity (ICCID) SIM serial number may be printed on the SIM card for identification.

The MSMS communication device 200 may include at least one controller, such as a general-purpose processor 206, which may be coupled to a coder/decoder (CODEC) 208. The CODEC 208 may in turn be coupled to a speaker 210 and a microphone 212. The general-purpose processor 206 may also be coupled to at least one memory 214. The memory 214 may be a non-transitory computer-readable storage medium that stores processor-executable instructions. The memory 214 may store an operating system (OS), as well as user application software and executable instructions. The memory 214 may also store application data, such as an array data structure.

The general-purpose processor 206 may be coupled to a modem 230. The modem 230 may include at least one baseband modem processor 216, which may be coupled to a memory 222 and a modulator/demodulator 228. The baseband modem processor 216 may include physically or logically separate baseband modem processors (e.g., BB1, BB2). The modulator/demodulator 228 may receive data from the baseband modem processor 216 and may modulate a carrier signal with encoded data and provide the modulated signal to one or more RF resources 218a, 218b for transmission. The modulator/demodulator 228 may also extract an information-bearing signal from a modulated carrier wave received from the one or more RF resources 218a, 218b, and may provide the demodulated signal to the baseband modem processor 216. The modulator/demodulator 228 may be or include a digital signal processor (DSP).

The baseband modem processor 216 may read and write information to and from the memory 222. The memory 222 may also store instructions associated with a protocol stack, such as protocol stack S1 222a and protocol stack S2 222b. The protocol stacks S1 222a, S2 222b generally include computer executable instructions to enable communication using a radio access protocol or communication protocol. Each protocol stack S1 222a, S2 222b typically includes network protocol layers structured hierarchically to provide networking capabilities. The modem 230 may include one or more of the protocol stacks S1 222a, S2 222b to enable communication using one or more RATs. The protocol stacks S1 222a, S2 222b may be associated with a SIM card (e.g., SIM-1 204a, SIM-2 204b) configured with a subscription. For example, the protocol stack S1 222a and the protocol stack S2 222b may be associated with the SIM-1 204a. The illustration of only two protocol stacks S1 222a, S2 222b is not intended as a limitation, and the memory 222 may store more than two protocol stacks (not illustrated).

Each SIM and/or RAT in the MSMS communication device 200 (e.g., SIM-1 204a, SIM-2 204b) may be coupled to the modem 230 and may be associated with or permitted to use an RF resource. The term “RF resource chain” may be used to refer to all of the circuitry used to send and receive RF signals, which may include the baseband modem processor 216 that performs baseband/modem functions for communicating with/controlling a RAT, one or more radio units including transmitter and receiver components that are shown as RF resources 218a, 218b (e.g., in FIG. 2), one or more of the wireless antennas 220a, 220b, and additional circuitry that may include one or more amplifiers and radios. The term “Rx chain” may be used to refer to a portion of an RF resource chain that may receive RF signals, and the term “Tx chain” may be used to refer to a portion of an RF resource that may transmit RF signals. In some embodiments, an RF resource may share a common baseband modem processor 216 (i.e., a single device that performs baseband/modem functions for all RATs on the MSMS communication device). In some embodiments, each RF resource may include the physically or logically separate baseband processors (e.g., BB1, BB2).

The RF resources 218a, 218b may include transceivers associated with one or more RATs and may perform transmit/receive functions for the MSMS communication device 200 on behalf of their respective RATs. The RF resources 218a, 218b may include separate transmit and receive circuitry. In some embodiments, the RF resource 218b may include only receive circuitry. The RF resources 218a, 218b may each be coupled to a wireless antenna (e.g., the first wireless antenna 220a and the second wireless antenna 220b). The RF resources 218a, 218b may also be coupled to the modem 230 (e.g., via the modulator/demodulator 228, the baseband modem processor 216, or another component).

In some embodiments, the general-purpose processor 206, memory 214, baseband processor(s) 216, and the RF resources 218a, 218b may be included in the MSMS communication device 200 as a system-on-chip. In some embodiments, the first and second SIMs 204a, 204b and their corresponding interfaces 202a, 202b may be external to the system-on-chip. Further, various input and output devices may be coupled to components on the system-on-chip, such as interfaces or controllers. Example user input components suitable for use in the MSMS communication device 200 may include, but are not limited to, a keypad 224 and a touchscreen display 226.

In some embodiments, the keypad 224, the touchscreen display 226, the microphone 212, or a combination thereof may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or receive a telephone number. As another example, the request to initiate the outgoing call may be in the form of a voice command received via the microphone 212. Interfaces may be provided between the various software modules and functions in the MSMS communication device 200 to enable communication between them.

Functioning together, the two SIMs 204a, 204b, the baseband processor(s) 216, RF resources 218a, 218b and the antennas 220a, 220b may enable communications on two or more RATs. For example, one SIM, baseband processor and RF resource may be configured to support two different RATs. In other embodiments, more RATs may be supported on the MSMS communication device 200 by adding more SIM cards, SIM interfaces, RF resources, and antennas for connecting to additional mobile networks.

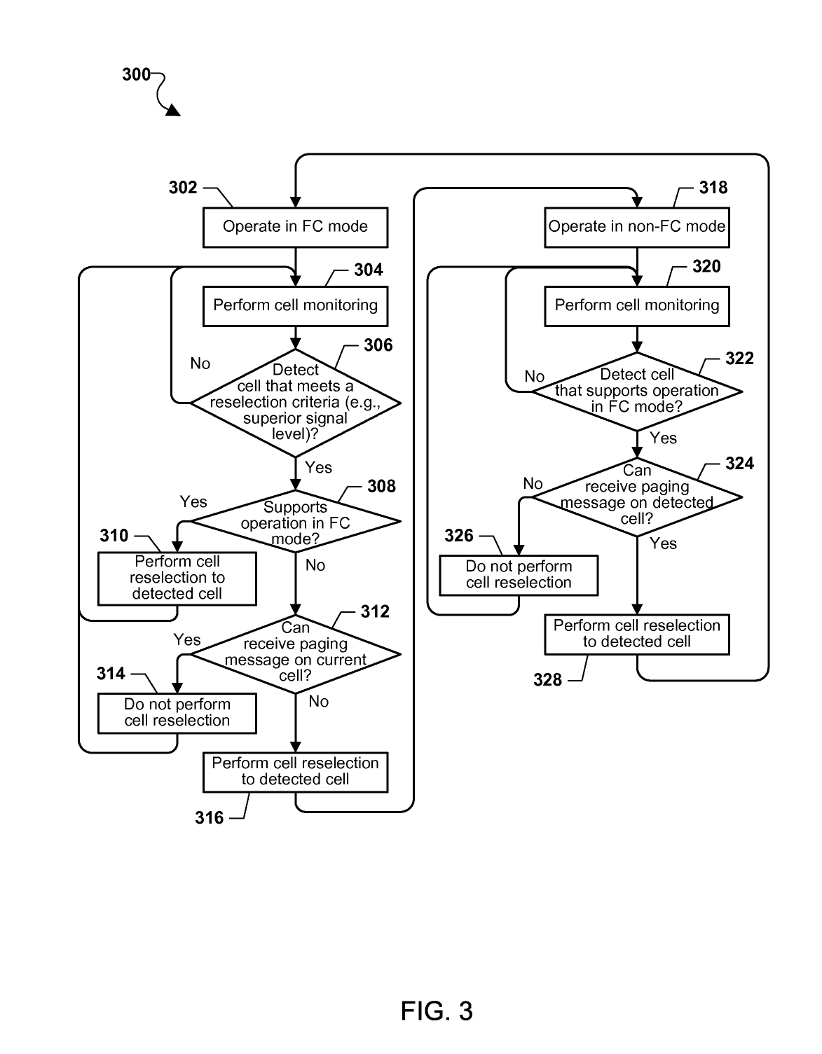

FIG. 3 illustrates a method 300 for managing cell selection performed by an MSMS communication device according to some embodiments. With reference to FIGS. 1-3, the method 300 may be implemented by an MSMS communication device (e.g., the MSMS communication device 102, 200), such as under the control of a processor (e.g., the general-purpose processor 206, the baseband processor 216, a separate controller, and/or the like) of the MSMS communication device (i.e., a device processor).

In block 302, the device processor may operate the MSMS communication device in the FC mode. When the MSMS communication device operates in the FC mode, the MSMS communication device may communicate with two cells, each using a different RAT (e.g., LTE and GSM). Each of these cells may be referred to as a current cell. For example, when operating in the FC mode, the MSMS device may communicate with a first current cell over a first signal using a first RAT (e.g., LTE) and with a second current cell over a second signal using a second RAT (e.g., GSM). In some embodiments, the first RAT may be associated with a first subscription, and the second RAT may be associated with a second subscription.

In block 304, the device processor may perform cell monitoring operations to monitor the signal levels of the current cells (i.e., the signal level of the first signal and the signal level of second signal), as well as signal levels of one or more additional cells (e.g., neighbor cells) that are detectable by the device processor. The signal level of the first signal, the second signal, and any other signals may include, for example, an RSRP, an RSSI, an RSRQ, a CQI, or another indication of signal strength or signal quality.

In determination block 306, the device processor may determine whether the device processor detects a cell that meets a reselection criteria. For example, the device processor may detect a cell having a signal level that is superior to the signal level of one of the current cells using the same RAT. In some embodiments, the detected cell may be a third cell. The signal from the detected cell (e.g., the detected third cell) may use the first RAT (which is also used by the first signal) or the second RAT (which is also used by the second signal). For example, the device processor may determine whether the device processor detects a third cell (e.g., a detected cell signal using GSM) with a higher signal level than a signal of one of the two current cells (e.g., a current cell signal using GSM). In response to determining that the device processor has not detected a cell that meets the reselection criteria, such as (but not limited to) having a signal level that is superior to the signal level of one of the current cells (i.e., determination block 306=“No”), the device processor may return to block 304 and perform cell monitoring.

In response to determining that the device processor has detected a cell that meets the reselection criteria, such as having a signal level that is superior to the signal level of one of the current cells (i.e., determination block 306=“Yes”), the device processor may determine whether the detected cell supports operation of the MSMS communication device in FC mode in determination block 308. In some embodiments, the device processor may determine whether the signal of the detected cell may interfere with signal reception by the MSMS communication device of the other RAT (i.e., interfere with the signal of the current cell using the other RAT). For example, the device processor may determine whether a frequency band used by the signal of the detected cell may interfere with a frequency band of the signal using the other RAT received by the MSMS communication device.

In response to determining that the detected cell supports operation of the MSMS communication device in the FC mode (i.e., determination block 308=“Yes”), the device processor may perform cell reselection to the detected cell in block 310. After the device processor performs cell reselection to the detected cell, the detected cell is considered a current cell. The device processor may again perform cell monitoring in block 304.

In response to determining that the detected cell does not support operation of the MSMS communication device in the FC mode (i.e., determination block 308=“No”), the device processor may determine whether the MSMS communication device can receive a paging message on the current cell in determination block 312. For example, the device processor may determine whether the MSMS communication device can receive a paging message over the signal of the current cell using the same RAT as the signal of the detected cell.

In response to determining that the MSMS communication device can receive a paging message over the signal of the current cell (i.e., determination block 312=“Yes”), the device processor may not perform cell reselection to the detected cell in block 314, and the device processor may return to performing cell monitoring in block 304. Thus, the device processor may not perform cell reselection to the detected cell, even if the detected cell's signal level is superior to the current cell's signal level, if the detected cell does not support operation of the MSMS communication device in the FC mode and the device processor can receive a paging message over the signal from the current cell.

The MSMS device may not be able to receive a paging message on the current cell for a number of reasons, such as due to mobility of the MSMS communication device, changes in network conditions (e.g., network congestion, data delay, data loss, or other conditions), and/or changes in wireless communication link conditions (e.g., RF interference, signal degradation, radio link congestion, and other communication link conditions). In some embodiments, the cell monitoring operations of block 304 may be triggered by a current cell signal level dropping below a signal level threshold.

In response to determining that the MSMS communication device cannot receive a paging message over the signal of the current cell (i.e., determination block 312=“No”), the device processor may perform cell reselection to the detected cell (i.e., the third cell) in block 316. In other words, the device processor may perform cell reselection to the detected cell, even when the detected cell does not support operation of the MSMS communication device in the FC mode, so that the MSMS communication device may receive a paging message of the detected cell's RAT.

In block 318, the device processor may operate in a non-FC mode. For example, the device processor may operate the MSMS communication device in, for example, DTA mode or full tune-away mode. In block 320, the device processor may perform cell monitoring to monitor the signal levels of the current cells. The device processor may also monitor signal levels of one or more additional cells that are detectable by the device processor. In particular, the device processor may conduct cell monitoring to identify a cell that will enable the MSMS device to operation in the FC mode.

In determination block 322, the device processor may determine whether the device processor detects a cell that supports operation of the MSMS communication device in the FC mode. In some embodiments, the detected cell may be a fourth cell. In some embodiments, the fourth cell may be a previously-selected cell or a cell that has not been selected previously. In some embodiments, the device processor may determine whether the signal of the detected cell will or could interfere with signal reception by the MSMS communication device of the other RAT (i.e., interfere with the signal of the current cell using the other RAT). For example, the device processor may determine whether a frequency band used for the signal of the detected cell will interfere with a frequency band of the signal using the other RAT received by the MSMS communication device. In some embodiments, the device processor may determine whether the signal level of the detected cell is less than or equal to the signal level of the current cell using the same RAT. In response to determining that the device processor does not detect a cell that supports operation in the FC mode (i.e., determination block 322=“No”), the device processor may continue performing cell monitoring in block 320.

In response to determining that the device processor detects a cell that supports operation in the FC mode (i.e., determination block 322=“Yes”), the device processor may determine whether the MSMS communication device can receive a paging message on the detected cell in determination block 324. For example, the device processor may determine whether the MSMS communication device can receive a paging message over the signal of the detected cell using the same RAT as the signal of a current cell that does not support operation in the FC mode.

In response to determining that the MSMS communication device cannot receive a paging message over the signal of the detected cell (i.e., determination block 322=“No”), the device processor may not perform cell reselection to the detected cell in block 326, and the device processor may continue performing cell monitoring in block 320.

In response to determining that the MSMS communication device can receive a paging message over the signal of the detected cell (i.e., determination block 324=“Yes”), the device processor may perform cell reselection to the detected cell in block 328. The device processor may then operate the MSMS device in the FC mode in block 302 and may return to performing cell monitoring in block 304 as described.

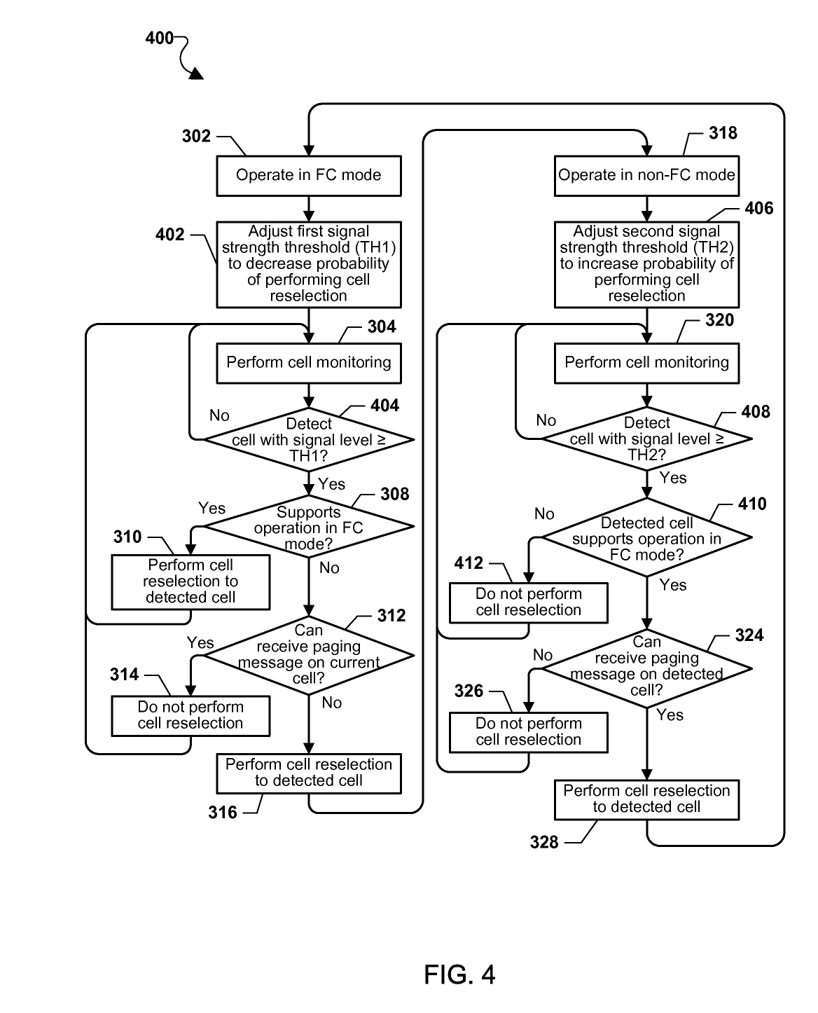

FIG. 4 illustrates a method 400 for managing cell selection performed by a MSMS communication device according to some embodiments. With reference to FIGS. 1-4, the method 400 may be implemented by an MSMS communication device (e.g., the MSMS communication device 102, 200), such as under the control of a processor (e.g., the general-purpose processor 206, the baseband processor 216, a separate controller, and/or the like) of the MSMS communication device (i.e., a device processor). In blocks 302-326, the device processor may perform operations of like numbered blocks of the method 300 as described.

In block 302, the device processor may operate the MSMS communication device in the FC mode. While operating in the FC mode, the device processor may adjust a first threshold to decrease a probability of performing cell reselection away from the current cells in block 402. In some embodiments, when the MSMS communication device is operating in the FC mode, the device processor may increase a first signal level threshold (TH1) required to select a third cell (i.e., to perform cell reselection to the third cell away from one of the current cells). Such an increase in the first signal level threshold may have the effect of biasing the MSMS communication device to remain camped on (i.e., in communication with) cells that permit the MSMS communication device to operate in the FC mode. By adjusting the first signal level threshold, the device processor may thus increase the signal quality requirements that will prompt cell reselection, effectively decreasing the probability of performing cell reselection away from current cells when the MSMS communication device is operating in the FC mode. In some embodiments, the adjusted first signal level threshold may be greater than the signal level of one or both of the current cells.

In determination block 404, the device processor may determine whether the device processor detects a cell having a signal level that is greater than or equal to the first signal level threshold (TH1). The signal from the detected cell may use the first RAT (which is also used by the first signal) or the second RAT (which is also used by the second signal). In response to determining that the device processor has not detected a cell having a signal level that is greater than or equal to the first signal level threshold (i.e., determination block 404=“No”), the device processor may continue performing cell monitoring in block 304.

In response to detecting a cell having a signal level that is greater than or equal to the first signal level threshold (i.e., determination block 404=“Yes”), the device processor may determine whether the detected cell supports operation of the MSMS communication device in the FC mode in determination block 308.

In response to determining that the detected cell supports operation of the MSMS communication device in the FC mode (i.e., determination block 308=“Yes”), the device processor may perform cell reselection to the detected cell in block 310, and again perform cell monitoring in block 304.

In response to determining that the detected cell does not support operation of the MSMS communication device in the FC mode (i.e., determination block 308=“No”), the device processor may determine whether the MSMS communication device can receive a paging message on the current cell in determination block 312. In response to determining that the MSMS communication device can receive a paging message over the signal of the current cell (i.e., determination block 312=“Yes”), the device processor may not perform cell reselection to the detected cell in block 314, and the device processor may return to performing cell monitoring in block 304.

In response to determining that the MSMS communication device cannot receive a paging message over the signal of the current cell (i.e., determination block 312=“No”), the device processor may perform cell reselection to the detected cell in block 316, and the device processor may begin operating in a non-FC mode in block 318 (e.g., DTA mode or full tune-away mode).

In block 406, the device processor may adjust a second threshold to increase a probability of performing cell reselection away from the current cells. For example, the device processor may adjust a second signal level threshold (TH2) to increase the probability of performing cell reselection to a cell that supports operation of the MSMS communication device in the FC mode. In some embodiments, when the MSMS communication device is operating in the non-FC mode, the device processor may decrease the second signal level threshold required to initiate cell reselection to a third cell (i.e., to perform cell reselection to the third cell away from the current cells). Decreasing the second signal level threshold required to initiate cell reselection may effectively bias the MSMS communication device to select a new cell (i.e., establish communication with cells) that enables the MSMS communication device to operate in the FC mode. By adjusting the second signal level threshold, the device processor may thus decrease the requirements for selecting any detected cell for cell reselection to increase the probability of performing cell reselection away from a current cell that does not enable the MSMS communication device to operate in the FC mode and to a detected cell that enables the MSMS communication device to operate in the FC mode. In some embodiments the adjusted second signal level threshold may be below a signal level of one or both of the current cells.

In determination block 408, the device processor may determine whether the device processor detects a cell having a signal level that is greater than or equal to the second signal level threshold (TH2). The signal from the detected cell may use the first RAT or the second RAT. In response to determining that the device processor has not detected a cell having a signal level that is greater than or equal to the second signal level threshold (i.e., determination block 408=“No”), the device processor may continue performing cell monitoring in block 320.

In response to detecting a cell having a signal level that is greater than or equal to the second signal level threshold (i.e., determination block 408=“Yes”), the device processor determine whether the detected cell supports operation of the MSMS communication device in the FC mode in determination block 410. In response to determining that the detected cell does not support operation in the FC mode (i.e., determination block 410=“No”), the device processor may not perform cell reselection to the detected cell in block 412, and the device processor may continue performing cell monitoring in block 320.

In response to determining that the detected cell supports operation in the FC mode (i.e., determination block 410=“Yes”), the device processor may determine whether the MSMS communication device can receive a paging message on the detected cell in determination block 324. In response to determining that the device MSMS communication device cannot receive a paging message on the detected cell (i.e., determination block 324=“No”), the device processor may not perform cell reselection to the detected cell in block 326, and the device processor may continue performing cell monitoring in block 320.

In response to determining that the MSMS communication device can receive a paging message over the signal of the detected cell (i.e., determination block 324=“Yes”), the device processor may perform cell reselection to the detected cell in block 328, and return to operating in the FC mode in block 302.

In some embodiments, when the detected cell and the current cell are providing the same mode of operation (both FC or both DTA), there may not be a change in thresholds in block 402 and/or block 406, and the MSMS communication device may use the legacy reselection algorithm. This will result in the reselection behavior remaining the same when both the source and target cells are providing the same mode of operation.

The various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the method 300 may be substituted for or combined with one or more operations of the method 400 and vice versa.

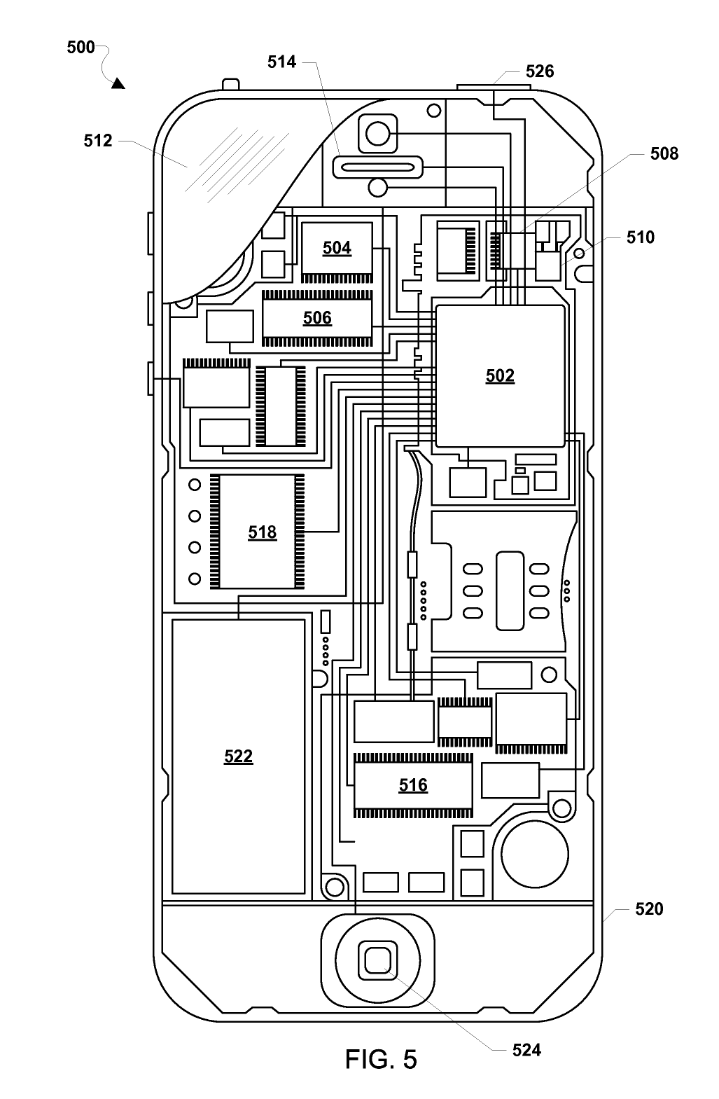

Various embodiments (including, but not limited to, embodiments described with reference to FIGS. 1-4) may be implemented in any of a variety of MSMS communication devices, an example of which (e.g., MSMS communication device 500) is illustrated in FIG. 5. With reference to FIGS. 1-5, in various embodiments, the MSMS communication device 500 (which may correspond, for example, to the MSMS communication devices 102 and 200) may include a processor 502 coupled to a touchscreen controller 504 and an internal memory 506. The processor 502 may be one or more multi-core integrated circuits designated for general or specific processing tasks. The internal memory 506 may be volatile or non-volatile memory, and may also be secure and/or encrypted memory, or unsecure and/or unencrypted memory, or any combination thereof. The touchscreen controller 504 and the processor 502 may also be coupled to a touchscreen panel 512, such as a resistive-sensing touchscreen, capacitive-sensing touchscreen, infrared sensing touchscreen, etc. Additionally, the display of the MSMS communication device 500 need not have touch screen capability.

The MSMS communication device 500 may have two or more radio signal transceivers 508 (e.g., Peanut, Bluetooth, ZigBee, Wi-Fi, RF radio) and antennae 510, for sending and receiving communications, coupled to each other and/or to the processor 502. The transceivers 508 and antennae 510 may be used with the above-mentioned circuitry to implement the various wireless transmission protocol stacks and interfaces. The MSMS communication device 500 may include one or more cellular network wireless modem chip(s) 516 coupled to the processor and antennae 510 that enables communication via two or more cellular networks via two or more radio access technologies.

The MSMS communication device 500 may include a peripheral device connection interface 518 coupled to the processor 502. The peripheral device connection interface 518 may be singularly configured to accept one type of connection, or may be configured to accept various types of physical and communication connections, common or proprietary, such as USB, FireWire, Thunderbolt, or PCIe. The peripheral device connection interface 518 may also be coupled to a similarly configured peripheral device connection port (not shown).

The MSMS communication device 500 may also include speakers 514 for providing audio outputs. The MSMS communication device 500 may also include a housing 520, constructed of a plastic, metal, or a combination of materials, for containing all or some of the components discussed herein. The MSMS communication device 500 may include a power source 522 coupled to the processor 502, such as a disposable or rechargeable battery. The rechargeable battery may also be coupled to the peripheral device connection port to receive a charging current from a source external to the MSMS communication device 500. The MSMS communication device 500 may also include a physical button 524 for receiving user inputs. The MSMS communication device 500 may also include a power button 526 for turning the MSMS communication device 500 on and off.

The processor 502 may be any programmable microprocessor, microcomputer or multiple processor chip or chips that can be configured by software instructions (applications) to perform a variety of functions, including the functions of various embodiments described below. In some MSMS communication devices, multiple processors 502 may be provided, such as one processor dedicated to wireless communication functions and one processor dedicated to running other applications. Typically, software applications may be stored in the internal memory 506 before they are accessed and loaded into the processor 502. The processor 502 may include internal memory sufficient to store the application software instructions.

The foregoing method descriptions and the process flow diagrams are provided merely as illustrative examples and are not intended to require or imply that the blocks of various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the various embodiments.

The hardware used to implement the various illustrative logics, logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of communication devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

In various embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present embodiments. Various modifications to these embodiments will be readily apparent to those skilled in the art, and the generic principles defined herein may be applied to other embodiments without departing from the scope of the embodiments. Thus, the various embodiments are not intended to be limited to the embodiments shown herein but are to be accorded the widest scope consistent with the following claims and the principles and novel features disclosed herein.

1. A method for managing cell selection performed by a processor of a multi-subscription multi-standby communication device, the method comprising:
selecting cells for reselection that will enable full concurrency mode operation by the multi-subscription multi-standby communication device after performing the reselection, comprising:
determining whether a first detected cell having a signal level superior to a signal level of a current cell will enable full concurrency mode operation by the multi-subscription multi-standby communication device; and
performing cell reselection to the first detected cell in response to determining that the first detected cell will enable full concurrency mode operation by the multi-subscription multi-standby communication device.

2. The method of claim 1, wherein selecting cells for reselection that will enable full concurrency mode operation by the multi-subscription multi-standby communication device after performing the reselection comprises:
performing the operations of:
determining whether the first detected cell having a signal level superior to a signal level of a current cell will enable full concurrency mode operation by the multi-subscription multi-standby communication device; and
performing cell reselection to the first detected cell in response to determining that the first detected cell will enable full concurrency mode operation by the multi-subscription multi-standby communication device while operating in a full concurrency mode;
the method further comprising, while operating in the full concurrency mode:
determining whether the current cell can receive paging messages in response to determining that the first detected cell will not enable full concurrency mode operation by the multi-subscription multi-standby communication device;
not performing cell reselection to the first detected cell in response to determining that the current cell can receive paging messages; and
performing cell reselection to the first detected cell and operating in a non-full concurrency mode in response to determining that the current cell cannot receive paging messages.

3. The method of claim 2, wherein selecting cells for reselection that will enable full concurrency mode operation by the multi-subscription multi-standby communication device after performing the reselection further comprises:
while operating in the non-full concurrency mode:
determining whether a second detected cell having a signal level superior to a signal level of the current cell will enable full concurrency mode operation by the multi-subscription multi-standby communication device;
determining whether the second detected cell will enable receiving paging messages in response to determining that the second detected cell will enable full concurrency mode operation by the multi-subscription multi-standby communication device;
not performing cell reselection to the second detected cell in response to determining that the second detected cell will not enable receiving paging messages; and
performing cell reselection to the second detected cell and operating in a full concurrency mode in response to determining that the second detected cell will enable receiving paging messages.

4. The method of claim 1, wherein selecting cells for reselection that will enable full concurrency mode operation by the multi-subscription multi-standby communication device after performing the reselection further comprises:
while operating in a full concurrency mode:
adjusting a first signal strength threshold for initiating cell reselection to decrease a probability of performing cell reselection;
wherein determining whether a first detected cell having a signal level superior to a signal level of a current cell will enable full concurrency mode operation by the multi-subscription multi-standby communication device comprises determining while operating in the full concurrency mode whether the first detected cell having a signal level superior to the signal level of the current cell exhibits a signal strength that exceeds the adjusted first signal strength threshold;
determining whether the first detected cell will enable full concurrency mode operation by the multi-subscription multi-standby communication device in response to determining that the first detected cell exhibits a signal strength that exceeds the adjusted first signal strength threshold;
wherein performing cell reselection to the first detected cell in response to determining that the first detected cell will enable full concurrency mode operation by the multi-subscription multi-standby communication device comprises performing while operating in the full concurrency mode cell reselection to the first detected cell in response to determining that the first detected cell will enable full concurrency mode operation by the multi-subscription multi-standby communication device;
determining whether the current cell can receive paging messages in response to determining that the first detected cell will not enable full concurrency mode operation by the multi-subscription multi-standby communication device;
not performing cell reselection to the first detected cell in response to determining that the current cell can receive paging messages; and
performing cell reselection to the first detected cell and operating in a non-full concurrency mode in response to determining that the current cell cannot receive paging messages.

5. The method of claim 4, wherein selecting cells for reselection that will enable full concurrency mode operation by the multi-subscription multi-standby communication device after performing the reselection further comprises:
while operating in the non-full concurrency mode:
adjusting a second signal strength threshold for initiating cell reselection to increase a probability of performing cell reselection;
determining whether a second detected cell exhibits a signal strength that exceeds the adjusted second signal strength threshold;
determining whether the second detected cell will enable receiving paging messages in response to determining that the second detected cell will enable full concurrency mode operation by the multi-subscription multi-standby communication device;
not performing cell reselection to the second detected cell in response to determining that the second detected cell will not enable receiving paging messages; and
performing cell reselection to the second detected cell and operating in the full concurrency mode in response to determining that the second detected cell will enable receiving paging messages.

6. The method of claim 5,
wherein adjusting the first signal strength threshold for initiating cell reselection to decrease the probability of performing cell reselection comprises increasing the first signal strength threshold, and
wherein adjusting the second signal strength threshold for initiating cell reselection to increase the probability of performing cell reselection comprises decreasing the second signal strength threshold.

7. A multi-subscription multi-standby communication device, comprising:
a memory;
a radio frequency (RF) resource configured to function in a full concurrency mode and a non-full concurrency mode; and
a processor coupled to the memory and the RF resource, and configured with processor-executable instructions to:
select cells for reselection that will enable full concurrency mode operation after performing the reselection, comprising:
determining whether a first detected cell having a signal level superior to a signal level of a current cell will enable full concurrency mode operation by the multi-subscription multi-standby communication device; and
performing cell reselection to the first detected cell in response to determining that the first detected cell will enable full concurrency mode operation by the multi-subscription multi-standby communication device.

8. The multi-subscription multi-standby communication device of claim 7, wherein the processor is further configured with processor-executable instructions to select cells for reselection that will enable full concurrency mode operation after performing the reselection such that the operations of:
determining whether the first detected cell having a signal level superior to a signal level of a current cell will enable full concurrency mode operation; and
performing cell reselection to the first detected cell in response to determining that the first detected cell will enable full concurrency mode operation are performed while the multi-subscription multi-standby communication device is operating in full concurrency mode; and
the processor is further configured with processor-executable instructions to select cells for reselection that will enable full concurrency mode operation while operating in full concurrency mode by:
determining whether the current cell can receive paging messages in response to determining that the first detected cell will not enable full concurrency mode operation;
not performing cell reselection to the first detected cell in response to determining that the current cell can receive paging messages; and
performing cell reselection to the first detected cell and begin operating in a non-full concurrency mode in response to determining that the current cell cannot receive paging messages.

9. The multi-subscription multi-standby communication device of claim 8, wherein the processor is further configured with processor-executable instructions to select cells for reselection that will enable full concurrency mode operation after performing the reselection while operating in the non-full concurrency mode by:
determining whether a second detected cell having a signal level superior to a signal level of the current cell will enable full concurrency mode operation by the multi-subscription multi-standby communication device;
determining whether the second detected cell will enable receiving paging messages in response to determining that the second detected cell will enable full concurrency mode operation by the multi-subscription multi-standby communication device;
not performing cell reselection to the second detected cell in response to determining that the second detected cell will not enable receiving paging messages; and
performing cell reselection to the second detected cell and begin operating in a full concurrency mode in response to determining that the second detected cell will enable receiving paging messages.

10. The multi-subscription multi-standby communication device of claim 7, wherein the processor is further configured with processor-executable instructions to select cells for reselection that will enable full concurrency mode operation after performing the reselection by:
while operating in the full concurrency mode:
adjusting a first signal strength threshold for initiating cell reselection to decrease a probability of performing cell reselection;
wherein determining whether a first detected cell having a signal level superior to a signal level of a current cell will enable full concurrency mode operation by the multi-subscription multi-standby communication device comprises determining while operating in the full concurrency mode whether a first detected cell having a signal level superior to a signal level of a current cell exhibits a signal strength that exceeds the adjusted first signal strength threshold;
determining whether the first detected cell will enable full concurrency mode operation by the multi-subscription multi-standby communication device in response to determining that the first detected cell exhibits a signal strength that exceeds the adjusted first signal strength threshold;
wherein performing cell reselection to the first detected cell in response to determining that the first detected cell will enable full concurrency mode operation by the multi-subscription multi-standby communication device comprises performing while operating in the full concurrency mode cell reselection to the first detected cell in response to determining that the first detected cell will enable full concurrency mode operation by the multi-subscription multi-standby communication device;
determining whether the current cell can receive paging messages in response to determining that the first detected cell will not enable full concurrency mode operation by the multi-subscription multi-standby communication device;
not performing cell reselection to the first detected cell in response to determining that the current cell can receive paging messages; and
performing cell reselection to the first detected cell and begin operating in a non-full concurrency mode in response to determining that the current cell cannot receive paging messages.

11. The multi-subscription multi-standby communication device of claim 10, wherein the processor is further configured with processor-executable instructions to select cells for reselection that will enable full concurrency mode operation after performing the reselection while operating in the non-full concurrency mode by:
adjusting a second signal strength threshold for initiating cell reselection to increase a probability of performing cell reselection;
determining whether a second detected cell exhibits a signal strength that exceeds the adjusted second signal strength threshold;
determining whether the second detected cell will enable receiving paging messages in response to determining that the second detected cell will enable full concurrency mode operation by the multi-subscription multi-standby communication device;
not performing cell reselection to the second detected cell in response to determining that the second detected cell will not enable receiving paging messages; and
performing cell reselection to the second detected cell and begin operating in a full concurrency mode in response to determining that the second detected cell will enable receiving paging messages.

12. The multi-subscription multi-standby communication device of claim 11, wherein the processor is further configured with processor-executable instructions to:
increase the first signal strength threshold for initiating cell reselection to decrease the probability of performing cell reselection, and
decrease the second signal strength threshold for initiating cell reselection to increase the probability of performing cell reselection.

13. A multi-subscription multi-standby communication device, comprising:
a radio frequency (RF) resource configured to function in a full concurrency mode and a non-full concurrency mode; and
means for selecting cells for reselection that will enable full concurrency mode operation of the multi-subscription multi-standby communication device after performing the reselection, comprising:
means for determining whether a first detected cell having a signal level superior to a signal level of a current cell will enable full concurrency mode operation by the multi-subscription multi-standby communication device; and
means for performing cell reselection to the first detected cell in response to determining that the first detected cell will enable full concurrency mode operation by the multi-subscription multi-standby communication device.

14. A non-transitory processor-readable storage medium having stored thereon processor-executable instructions configured to cause a processor of a multi-subscription multi-standby communication device to perform operations comprising:
selecting cells for reselection that will enable full concurrency mode operation by the multi-subscription multi-standby communication device after performing the reselection, comprising:
determining whether a first detected cell having a signal level superior to a signal level of a current cell will enable full concurrency mode operation by the multi-subscription multi-standby communication device; and
performing cell reselection to the first detected cell in response to determining that the first detected cell will enable full concurrency mode operation by the multi-subscription multi-standby communication device.

15. The non-transitory processor-readable storage medium of claim 14, wherein the stored processor-executable instructions are configured to cause a processor of a multi-subscription multi-standby communication device to perform operations such that selecting cells for reselection that will enable full concurrency mode operation by the multi-subscription multi-standby communication device after performing the reselection further comprises:
performing the operations of:
determining whether the first detected cell having a signal level superior to a signal level of a current cell will enable full concurrency mode operation by the multi-subscription multi-standby communication device; and
performing cell reselection to the first detected cell in response to determining that the first detected cell will enable full concurrency mode operation by the multi-subscription multi-standby communication device while the multi-subscription multi-standby communication device is operating in full concurrency mode; and
selecting cells for reselection that will enable full concurrency mode operation by the multi-subscription multi-standby communication device further comprises, while operating in full concurrency mode:
determining whether the current cell can receive paging messages in response to determining that the first detected cell will not enable full concurrency mode operation by the multi-subscription multi-standby communication device;
not performing cell reselection to the first detected cell in response to determining that the current cell can receive paging messages; and
performing cell reselection to the first detected cell and begin operating in a non-full concurrency mode in response to determining that the current cell cannot receive paging messages.

16. The non-transitory processor-readable storage medium of claim 15, wherein the stored processor-executable instructions are configured to cause a processor of a multi-subscription multi-standby communication device to perform operations such that selecting cells for reselection that will enable full concurrency mode operation by the multi-subscription multi-standby communication device after performing the reselection further comprises:
while operating in the non-full concurrency mode:
determining whether a second detected cell having a signal level superior to a signal level of the current cell will enable full concurrency mode operation by the multi-subscription multi-standby communication device;
determining whether the second detected cell will enable receiving paging messages in response to determining that the second detected cell will enable full concurrency mode operation by the multi-subscription multi-standby communication device;
not performing cell reselection to the second detected cell in response to determining that the second detected cell will not enable receiving paging messages; and
performing cell reselection to the second detected cell and begin operating in a full concurrency mode in response to determining that the second detected cell will enable receiving paging messages.

17. The non-transitory processor-readable storage medium of claim 14, wherein the stored processor-executable instructions are configured to cause a processor of a multi-subscription multi-standby communication device to perform operations such that selecting cells for reselection that will enable full concurrency mode operation by the multi-subscription multi-standby communication device after performing the reselection further comprises:
while operating in a full concurrency mode:
adjusting a first signal strength threshold for initiating cell reselection to decrease a probability of performing cell reselection;
wherein determining whether a first detected cell having a signal level superior to a signal level of a current cell will enable full concurrency mode operation by the multi-subscription multi-standby communication device comprises determining while operating in the full concurrency mode whether a first detected cell having a signal level superior to a signal level of a current cell exhibits a signal strength that exceeds the adjusted first signal strength threshold;
determining whether the first detected cell will enable full concurrency mode operation by the multi-subscription multi-standby communication device in response to determining that the first detected cell exhibits a signal strength that exceeds the adjusted first signal strength threshold;
wherein performing cell reselection to the first detected cell in response to determining that the first detected cell will enable full concurrency mode operation by the multi-subscription multi-standby communication device comprises performing while operating in the full concurrency mode cell reselection to the first detected cell in response to determining that the first detected cell will enable full concurrency mode operation by the multi-subscription multi-standby communication device;
determining whether the current cell can receive paging messages in response to determining that the first detected cell will not enable full concurrency mode operation by the multi-subscription multi-standby communication device;
not performing cell reselection to the first detected cell in response to determining that the current cell can receive paging messages; and
performing cell reselection to the first detected cell and begin operating in a non-full concurrency mode in response to determining that the current cell cannot receive paging messages.

18. The non-transitory processor-readable storage medium of claim 17, wherein the stored processor-executable instructions are configured to cause a processor of a multi-subscription multi-standby communication device to perform operations such that selecting cells for reselection that will enable full concurrency mode operation by the multi-subscription multi-standby communication device after performing the reselection further comprises:
while operating in the non-full concurrency mode:
adjusting a second signal strength threshold for initiating cell reselection to increase a probability of performing cell reselection;
determining whether a second detected cell exhibits a signal strength that exceeds the adjusted second signal strength threshold;
determining whether the second detected cell will enable receiving paging messages in response to determining that the second detected cell will enable full concurrency mode operation by the multi-subscription multi-standby communication device;
not performing cell reselection to the second detected cell in response to determining that the second detected cell will not enable receiving paging messages; and
performing cell reselection to the second detected cell and begin operating in a full concurrency mode in response to determining that the second detected cell will enable receiving paging messages.

19. The non-transitory processor-readable storage medium of claim 18, wherein the stored processor-executable instructions are configured to cause a processor of a multi-subscription multi-standby communication device to perform operations such that:
adjusting the first signal strength threshold for initiating cell reselection to decrease the probability of performing cell reselection comprises increasing the first signal strength threshold, and
adjusting the second signal strength threshold for initiating cell reselection to increase the probability of performing cell reselection comprises decreasing the second signal strength threshold.

20. The method of claim 1, wherein the signal level comprises one or more of a Receive Signal Strength Indicator (RSSI), a Reference Signal Received Power (RSRP), a Channel Quality Indicator (CQI), and a Reference Signal Received Quality (RSRQ).

21. The method of claim 20, wherein determining whether a first detected cell having a signal level superior to a signal level of a current cell will enable full concurrency mode operation by the multi-subscription multi-standby communication device comprises determining whether the signal level of the first detected cell is higher than a respective signal level of the current cell.

22. The multi-subscription multi-standby communication device of claim 7, wherein the signal level comprises one or more of a Receive Signal Strength Indicator (RSSI), a Reference Signal Received Power (RSRP), a Channel Quality Indicator (CQI), and a Reference Signal Received Quality (RSRQ).

23. The multi-subscription multi-standby communication device of claim 22, wherein the processor is further configured with processor-executable instructions such that determining whether a first detected cell having a signal level superior to a signal level of a current cell will enable full concurrency mode operation by the multi-subscription multi-standby communication device comprises determining whether the signal level of the first detected cell is higher than a respective signal level of the current cell.

24. The multi-subscription multi-standby communication device of claim 13, wherein the signal level comprises one or more of a Receive Signal Strength Indicator (RSSI), a Reference Signal Received Power (RSRP), a Channel Quality Indicator (CQI), and a Reference Signal Received Quality (RSRQ).

25. The multi-subscription multi-standby communication device of claim 24, wherein means for determining whether a first detected cell having a signal level superior to a signal level of a current cell will enable full concurrency mode operation by the multi-subscription multi-standby communication device comprises means for determining whether the signal level of the first detected cell is higher than a respective signal level of the current cell.

26. The non-transitory processor-readable storage medium of claim 14, wherein the stored processor-executable instructions are configured to cause a processor of a multi-subscription multi-standby communication device to perform operations such that the signal level comprises one or more of a Receive Signal Strength Indicator (RSSI), a Reference Signal Received Power (RSRP), a Channel Quality Indicator (CQI), and a Reference Signal Received Quality (RSRQ).

27. The method of claim 26, wherein the stored processor-executable instructions are configured to cause a processor of a multi-subscription multi-standby communication device to perform operations such that determining whether a first detected cell having a signal level superior to a signal level of a current cell will enable full concurrency mode operation by the multi-subscription multi-standby communication device comprises determining whether the signal level of the first detected cell is higher than a respective signal level of the current cell.
